(19) United States
(12) Patent Application Publication
(10) Pub. No.: US 2019/0084362 A1
(43) Pub. Date: Mar. 21, 2019

(54) SUPPORTING ELEMENT COMPRISING A SENSOR

(71) Applicant: WESTFALIA-AUTOMOTIVE GMBH, Rheda-Wiedenbruck (DE)

(72) Inventors: Bernhard SIELHORST, Rheda-Wiedenbruck (DE); Hendrik Lotter, Melle (DE)

(21) Appl. No.: 16/083,647

(22) PCT Filed: Mar. 21, 2017
(86) PCT No.: PCT/EP2017/056635

§ 371 Date: Sep. 10, 2018

(30) Foreign Application Priority Data
Mar. 23, 2016 (DE) 102016105509.3
Mar. 24, 2016 (DE) 102016105604.9
Jun. 7, 2016 (DE) 102016110460.4

(51) Int. Cl. B60D 1/24; B60D 1/06; B60D 1/62; G01B 21/32; G01L 1/12

(52) U.S. Cl. CPC B60D 1/248; B60D 1/06; G01L 1/122; G01B 21/32; B60D 1/62

(57) ABSTRACT

The invention relates to a supporting element as a component of a motor vehicle trailer coupling or other trailer or a load carrier provided for coupling to a motor vehicle trailer coupling, wherein the supporting element (60-63) has at least one sensor (40) for sensing a deformation of the supporting element (60-63) by a load acting on the supporting element (60-63), wherein at least one recess (21, 121) for the at least one sensor (40) is provided on the supporting element (60-63), in the region of a supporting section (31; 331; 731), which deforms during the loading by the load, of the supporting element (60-63), wherein the at least one sensor (40) is provided for measuring a distance from reference areas (25, 26) of the at least one recess (21, 121). There is provision that the supporting element (60-63) is configured as a profiled body (665, 765) with at least two supporting walls (660, 761) which are angled or connected to one another via an arcuate section (769) and which enclose an intermediate space or cavity (664, 764), wherein at least one of the reference areas (25, 26) is provided on a passage opening in the profiled body (665, 765) or on an indicator element (736, 737) which protrudes in front of the profiled body (665, 765), and the reference areas (25, 26) move relative to one another, in particular towards one another or away from one another, during the deformation of the supporting element (60-63).

The invention relates to a supporting element as a component of a motor vehicle trailer coupling or of a trailer intended for coupling to a motor vehicle trailer coupling or of a load carrier, the supporting element having at least one sensor for sensing a deformation of the supporting element caused by a load acting on the supporting element, at least one recess being provided in the supporting element for the at least one sensor in the region of a supporting section, which deforms when stressed by the load, of the supporting element, the at least one sensor being provided for measuring a spacing of reference surfaces of the at least one recess.

DE 10 2014 013 812.7 describes the arrangement of a sensor in a recess in the coupling arm. The sensor is, for example, adhesively bonded or screwed together with surfaces of the recess which deform when stressed by the load acting on the trailer coupling. A sensor having two sensor parts is described, the spacing of which changes during the stress and thus the deformation of the supporting element in the form of the coupling arm. The sensor elements are stressed mechanically by the deformation of the supporting element.

It is therefore the object of the invention to provide an improved supporting element as a component of a motor vehicle trailer coupling or of a trailer intended for coupling to a motor vehicle trailer coupling or of a load carrier, having a sensor for detecting a deformation of the supporting element by a load acting on the supporting element.

To achieve the object, in the case of a supporting element of the type mentioned at the outset, it is provided that the supporting element is configured as a profiled body having at least two supporting walls which are at an angle to one another or are interconnected by an arcuate section and include an intermediate space or cavity, at least one of the reference surfaces being provided on a passage opening of the profiled body or on an indicator element which protrudes in front of the profiled body, and the reference surfaces moving relative to one another, in particular towards one another or away from one another during the deformation of the supporting element.

The profiled body has at least two supporting walls, preferably a plurality of supporting walls which are at an angle to one another or run, for example, over an arcuate section, so that it has a particularly high stability. It is a basic concept of the present invention that, when stressed, the profiled body undergoes a deformation which can be detected by the sensor.

The passage opening is arranged in one of the supporting walls, for example.

The at least one indicator element is, for example, integral with the supporting wall or is connected to the supporting wall.

The at least one indicator element is preferably a stamped part or a stamped bent part which has been stamped out of a wall body of the respective supporting wall and has optionally been subjected to a bending deformation procedure.

A reference surface can be a reference surface which directly delimits a gap of the recess. The reference surface can also be a reference surface which is present beside the recess or at the recess, but which indicates or takes part in a movement in the region of the recess.

It is possible for both reference surfaces to be arranged on the same supporting wall, for example on a recess or passage opening of the supporting wall and/or on an indicator element which is connected to the supporting wall, in particular is integral therewith.

It is also possible for one reference surface to be arranged on a first supporting wall and for the other reference surface to be arranged on a second supporting wall of the profiled body. The supporting walls can, for example, be directly adjacent to one another and directly interconnected, or they can be connected together via an arcuate section, at an angle to one another as it were. Furthermore, it is possible for the first supporting wall and the second supporting wall to run parallel to one another for example, i.e. to form for example an upper and lower or a front and rear supporting wall of the profiled body. A corresponding indicator element can protrude in front of the supporting walls, for example.

The profiled body can be used in various ways, for example as a supporting element of a trailer coupling, for example as a cross member which is to be attached at the rear to the bodywork of the motor vehicle, and/or as a side support or longitudinal member or longitudinal fastening profile which is oriented on the motor vehicle in the longitudinal direction thereof. Longitudinal members or side supports can project from a cross member, for example, and can be provided for connection to longitudinal members of the bodywork of the motor vehicle. Furthermore, it is possible for the profiled body to form a component of a coupling arm of the trailer coupling. A coupling element, for example a coupling ball is expediently arranged on the free end region of the coupling arm. However, it is also possible for the profiled body not to form a coupling arm of a trailer coupling and/or for it not to be arranged on a coupling arm of the trailer coupling.

The profiled body particularly preferably forms a component of a support arrangement which is intended to be attached to the motor vehicle or is attached to the motor vehicle and on which a coupling arm of a trailer coupling is arranged or can be arranged in a fixed or detachable or movable manner, in particular in a pivotally movable manner, between a use position provided for the use of the trailer coupling, for example for coupling a trailer or attaching a load carrier, and a non-use position which is in particular adjusted towards the motor vehicle and is advantageously concealed behind and/or under a bumper of the motor vehicle. The detachable coupling arm can be inserted into an insertion seat, for example, which is arranged on the support arrangement.

It is also possible for the supporting element or the profiled body to form a component of a trailer, in particular to form the chassis thereof. For example, the profiled body or the supporting element can be arranged on a tow bar of the trailer.

It is quite possible for the supporting element to form a component of a load carrier, for example a bicycle rack or another carrier which can be mounted in a detachable manner on a trailer coupling of a motor vehicle. The load carrier is preferably a rear load carrier to be arranged on the rear of the motor vehicle. Furthermore, the load carrier can be mounted adjustably on the motor vehicle in the manner of a drawer, for example it can be pulled out of a mount on the rear of the motor vehicle and pushed in again. However, the load carrier can also be a roof load carrier to be attached to the roof of the motor vehicle, or a tailgate carrier to be attached to the tailgate, in particular to a boot lid of the motor vehicle. The supporting element is preferably a component of a supporting frame of the load carrier. The supporting element can, however, also be arranged on a load carrier coupling of the load carrier, or it can form a component of a load carrier coupling. The supporting element can be, for example, a component of a coupling housing of the load carrier coupling, or it can form a coupling housing. The load carrier coupling is preferably used to connect the load carrier in a detachable manner to a coupling element of the motor vehicle, for example to a coupling ball.

It is possible for the profiled body or supporting element to be exclusively a component of a trailer or of a load carrier. In particular, it is possible not to use the supporting element for motor vehicle trailer couplings, but exclusively in connection with trailers or load carriers.

It is possible for one or both of the reference surfaces to be provided on the passage opening of the profiled body. The passage opening is a deliberate weakening of the supporting wall, as it were, which is why a deformation of the supporting element can be detected particularly advantageously there.

Furthermore however, it is also advantageous to arrange one or both reference surfaces on a projection, in particular on a tongue-like projection or indicator element. The projection or indicator element intensifies, as it were, the relative movement which occurs at the foot of the projection or indicator element, so that the reference surface which is preferably provided in a region remote from the foot of the indicator element undergoes a particularly wide movement.

Cooperation between a reference surface on the passage opening and a reference surface on an indicator element is quite possible.

The profiled body can have different geometric configurations, in particular different cross-sectional configurations. Thus, it is advantageous if the supporting walls are at right angles to one another. This is possible, for example, if the profiled body has an L-shaped or T-shaped or U-shaped cross section. A square or rectangular cross section of the profiled body, for example, is particularly preferred. Furthermore, it is possible for the profiled body to have curves or for it to be configured as a round profile.

The profiled body can be a laterally open profile, for example a U-shaped profile or an L-shaped profile or a T-shaped profile.

However, it is also possible for the profiled body to be a closed profile which has a cavity. The closed profile can be a round profile, for example. However, polygonal, for example square or rectangular cross sections of the profile are also quite possible.

The supporting walls preferably have approximately the same thickness, for example between 0.5 mm and 5 mm, more preferably between 1 mm and 3 mm.

A thickness of the supporting walls over the entire cross-sectional extent thereof relative to the adjacent supporting wall is preferably the same or substantially the same.

Furthermore, it is advantageous if an arcuate section which connects adjacent supporting walls and which forms, for example, a side edge of the profiled body also has the same thickness as at least one supporting wall which directly adjoins the arcuate section.

The supporting walls are preferably flat walls or plate-like.

It is preferred if the reference surfaces are arranged next to the supporting section of the supporting element. The reference surfaces preferably have a distance from the supporting section, for example a transverse distance and/or a longitudinal distance with respect to the force flow direction through the supporting section and/or with respect to a surface or side face of the supporting section. The transverse distance and/or longitudinal distance is for example at most 5 cm, preferably at most 4 cm, in particular less than 3 cm or 2 cm. A particularly favourable transverse distance and/or longitudinal distance is within a range of from 2 to 5 mm.

The reference surfaces preferably extend transversely, in particular at right angles to or approximately at right angles to a supporting section, which deforms when stressed by the load, of the supporting element.

It is preferably provided that the reference surfaces extend transversely to a force flow direction through the supporting section of the supporting element.

The reference surfaces are advantageously free from a force flow through the supporting section of the supporting element, which force flow is transmitted from the supporting section, when stressed by the load acting on the supporting element. Particularly in this case it is quite possible that the reference surfaces do not run transversely to the supporting section, which deforms when stressed, of the supporting element, but they run overall or at least in portions along and/or parallel thereto.

The sensor which is arranged and/or which is measuring in the at least one recess or next to the at least one recess is expediently protected against environmental influences. In particular, it cannot be damaged by an item rubbing along the supporting element, for example.

In an advantageous embodiment, the at least one recess forms or comprises an expansion joint. Opposing walls of the expansion joint advantageously form the reference surfaces for the at least one sensor.

It is also possible for surfaces which are angled with respect to the walls of the recess, for example of the expansion joint or movement joint, for example approximately rectangular surfaces, to form reference surfaces.

It is advantageous if the recess extends transversely to a longitudinal direction of the supporting section and/or transversely to the force direction of the force or load passing through the supporting section.

Support loads and/or tensile loads and/or shear loads which act on the supporting element, for example, can advantageously be measured in an optimum manner. It is also possible in the case of a recess which runs or is arranged in this way to measure forces acting on the supporting element in the transverse direction of the vehicle. The recess runs, for example, in the transverse direction of the motor vehicle or trailer.

However, it is also possible, for example, in order to measure transverse forces of this type, i.e. forces which run for example in a so-called Y direction, for a recess with corresponding reference surfaces to run transversely to the longitudinal direction of the supporting element. For example, the recess can run in the longitudinal direction of the vehicle.

Thus, it is advantageously provided that the at least one recess runs in the transverse direction or in the longitudinal direction of the motor vehicle or trailer or load carrier when the load carrier is mounted on the motor vehicle.

However, it is also possible for a recess to run in an oblique direction, i.e. for example at an angle between the transverse direction and the longitudinal direction of the vehicle.

It is possible for the at least one sensor to be received fully or completely in the recess. However, it is also possible for the sensor to only be associated with the recess, so that the at least one sensor can measure a spacing of the reference surfaces of the recess. Thus, an embodiment is conceivable in which the sensor is not fully received in the interspace or interior of the recess.

The reference surfaces can run parallel to one another. However, it is also possible for the reference surfaces to have an oblique course or an angular position relative to one another and/or to have angular portions and/or curved portions.

When the supporting element is stressed, the reference surfaces can undergo a relative movement towards one another or away from one another in respect of their maximum extent. However, it is also possible that the reference surfaces are movable relative to one another in the manner of a shear movement. A shear movement can arise, for example, during a torsional loading of the supporting element or profiled body.

A plurality of sensors can be arranged on a respective reference surface. The sensors are expediently arranged next to one another transversely to a direction of a force flow or transversely to a force flow direction running through the supporting section.

The configuration according to the invention of the supporting element is easily realisable, for example, in the case of a cross member, a longitudinal member or another supporting element of a trailer coupling.

The supporting element can naturally have a plurality of sensors and/or also a plurality of recesses. It is thus possible to detect the deformation of the supporting element in a plurality of locations.

The reference surfaces are expediently free from a force flow which is transmitted from the supporting section during loading by the load acting on the supporting element. The reference surfaces are advantageously located next to a force flow which passes through the supporting section. Therefore, the force flow runs past the reference surfaces, as it were, at the same time ensuring that the reference surfaces move relative to one another, which is then detected by the at least one sensor. The reference surfaces can thus move relative to one another without a direct transmission of force or deformation and, according to the invention, the distance between these reference surfaces forms a measurement or indication of the deformation of the supporting element.

The reference surfaces of the supporting section or supporting element are advantageously integral with a basic body of the supporting section or supporting element.

It is preferred if the reference surfaces extend transversely, in particular at right angles or approximately at right angles transversely to a force flow direction which runs through the supporting section.

However, it is also possible for one reference surface or for the reference surfaces to extend with at least one direction component parallel to or along the force flow direction. Particularly in this case, it is advantageous if the reference surfaces are free from a force flow through the supporting section of the supporting element, which force flow is transmitted from the supporting section during loading by the load acting on the supporting element.

It is expediently provided that at least one of the reference surfaces is provided on a tongue-like or arm-like indicator element. It is preferred if an indicator element of this type protrudes freely in front of a basic body of the supporting element. Thus, the at least one indicator element forms, for example, a tongue or an arm.

For example, it is possible for the indicator element having a reference surface to be moved relative to a further indicator element having a further reference surface when the supporting element is stressed, or for both the indicator elements to be movable relative to one another. Both indicator elements can be configured, for example as tongues or arms.

However, it is also possible that only one indicator element is provided which is mounted on a reference surface, which is stationary relative to the supporting element, such that it is movable towards or away from this reference surface. For example, the other reference surface can be provided on the passage opening of the profiled body.

The at least one indicator element is preferably integral with a basic body of the supporting section or supporting element.

The reference surfaces are expediently arranged on mutually facing end faces of the indicator elements. However, it is also possible for a lateral face of an indicator element, which lateral face is angled relative to an end face, to form a reference surface. It is possible for lateral faces, forming reference surfaces, of indicator elements to be moved relatively towards one another or away from one another when the supporting element is stressed by a load acting thereon.

It is also possible for a reference surface to be provided on a projection which is not stressed by the force flow during the loading of the supporting element. For example, it is possible for one of the reference surfaces to be provided on a projection of this type, while the other reference surface is provided on an arm-like projection.

It is preferred if the reference surfaces are arranged on mutually opposite or adjacently arranged indicator elements or indicator arms which are free from a force flow.

A sensor element is advantageously at least indirectly coupled in terms of movement or connected to the reference surface which is free from the force flow through the supporting section.

A distance between the reference surfaces is, for example, at most 5 cm, preferably at most 4 cm, in particular less than 3 cm or 2 cm. A particularly advantageous distance between the reference surfaces is within a range of from 2 to 5 mm.

In the case of a supporting element which forms, for example, a component of a cross member of a trailer coupling (for mounting on the bodywork of a motor vehicle) or of a trailer (for example the chassis thereof) or of a load carrier, for example the supporting frame thereof, it is preferred if the at least one recess for the at least one sensor runs in a transverse direction of the motor vehicle or trailer. The vehicle transverse direction is oriented transversely, in particular at right angles transversely to the longitudinal direction of the motor vehicle, namely to the preferred direction of movement of the motor vehicle. This vehicle transverse direction is also called the Y direction. The reference surfaces preferably run parallel to or approximately parallel to the Y direction. This arrangement is particularly suitable for the measurement of support loads or tensile loads which act on the supporting element. The force directions of the support load and of the tensile load are also called the Z direction and the X direction.

An expedient embodiment of the invention provides that at least two sensor elements or at least two sensors are associated with one of the reference surfaces. Pairs of in each case two sensor elements are preferred, which are arranged opposite one another on the recess or laterally next to the recess. It is possible for at least two such pairs of sensor elements to be arranged on or next to the recess.

It is particularly preferred if a plurality of sensors or sensor elements is arranged in juxtaposition in the Y direction or vehicle transverse direction, next to or in a recess or expansion joint of the supporting element, which recess or expansion joint extends in the Y direction or vehicle transverse direction, or if a plurality of sensors or sensor elements is associated with the reference surface acting in juxtaposition in a row direction.

A row arrangement of at least two sensors or sensor elements is preferably provided in juxtaposition on a respective reference surface. However, a two-dimensional arrangement, as it were, is also possible, i.e. that at least two sensors or sensor elements are arranged in juxtaposition on a respective reference surface in directions which are at an angle to one another, or they are associated with the reference surface in these angled directions. Thus, the sensors or sensor elements can be arranged, for example linearly next to one another or multidimensionally, for example in the manner of a matrix, on the respective reference surface, or they can be associated in this form with the reference surface.

The at least one recess preferably comprises a depression which extends away from an opening in an outer surface of the supporting element, or it is formed by the depression. The reference surfaces are expediently at an angle, for example they are orthogonal, to the opening. However, it is pointed out here that the at least one recess can also be provided as it were in a core region of the supporting element, for example as a type of hole. However, if the recess is formed in an outer surface or extending away from an outer surface, a maximum deformation as it were can thereby be measured by the sensor.

The recess is preferably slot-shaped. The recess is therefore preferably relatively narrow and/or is provided in a groove. The groove can be U-shaped in cross section, for example. A groove which widens in the region of its base is preferred for example, the reference surfaces being provided remote from the base of the groove, on a narrower portion. Therefore, as it were, a widened or broadened groove base is present which is described in the following as an expansion cavity. A T-shape, for example, is particularly preferred, which will become clearer later on.

An expansion cavity is expediently arranged or provided between the supporting section and the reference surfaces. A cross width of the expansion cavity in a direction parallel to the distance between the reference surfaces is expediently greater than the distance between the reference surfaces.

The term “expansion cavity” can be understood in the sense of an expansion or widening, but also in the sense of a compression. In other words, it would also be possible to talk about a compression cavity to express the bidirectional mobility of the reference surfaces which is improved by the expansion cavity during a respective deformation of the supporting element.

Consequently, a particularly great deflection of the reference surfaces relative to one another is possible. The expansion cavity runs for example at an angle, in particular at right angles to the aforementioned depression on which the reference surfaces are provided.

The recess and the expansion cavity can have overall a keyhole-type shape or an oval or elliptical or egg shape. A wider region of the keyhole-shaped or oval cavity or recess then forms the expansion cavity for example, while the narrower region forms the recess for the at least one sensor.

The recess and the expansion cavity are expediently T-shaped. For example, the recess forms a longitudinal side, in particular a longitudinal side which extends away from an outer surface of the supporting element towards the inner region thereof, the expansion cavity forming a transverse side to the longitudinal side, in particular a transverse side which runs orthogonally or at another angle transversely to the longitudinal side.

However, the recess and the expansion cavity can also have a keyhole-type shape.

Arms, so to speak, protrude from the supporting section. It is preferred if the reference surfaces are provided on free end regions of arms which protrude from the supporting region. The arms are preferably L-shaped and/or have sides which are angled with respect to one another.

It is preferred if the at least one sensor does not protrude in front of an outer surface of the supporting element.

It is pointed out here that by adapting the configuration of expansion cavity and/or recess, for example the shape and/or size or the like, the desired deflection conditions between the reference surfaces can be easily influenced and adapted to the respective requirements in terms of measurement or stress. Thus, for example, a small recess and/or expansion cavity which only slightly influences the bearing capacity of the supporting element can be deliberately provided. On the one hand, greater distances and/or a larger expansion cavity can indeed weaken the bearing capacity of the supporting element to a slightly greater extent, but on the other hand can ensure greater deflections of the reference surfaces relative to one another.

It is advantageously provided that the supporting element or the assembly (trailer coupling, load carrier or trailer) comprising the supporting element and/or the at least one sensor has, in particular integrally, an evaluation means for evaluating at least one signal from the at least one sensor. The evaluation means has, for example, a microprocessor for processing signals from the at least one sensor and/or a memory for storing sensor signals. It is preferred if the evaluation means is configured to evaluate signals relating to at least one force direction, preferably to at least two force directions.

The at least one sensor is expediently configured to detect a deformation of the supporting element when stressed in the direction of a vertical axis during use of the supporting element and/or at least one horizontal axis during use of the supporting element. For example, the at least one sensor is configured to detect a deformation of the supporting element when stressed by a support load, in particular by a support load acting on the coupling ball or the coupling element, a support load during loading of the load carrier or trailer. However, additionally or alternatively, the at least one sensor is expediently also configured to detect at least one force acting along a horizontal axis, for example a shear force or tensile force, in particular a force in the direction of a vehicle longitudinal direction and/or in the direction of a transverse direction of the motor vehicle. Therefore, it is possible that the at least one sensor can also detect a plurality of force directions. Furthermore, it is possible for the at least one sensor to be configured to detect a torsion which acts on the supporting element.

For example, during torsion of the supporting element, in particular during a torsion about the longitudinal axis thereof, the reference surfaces can undergo a shear movement relative to one another which can be measured by the sensor.

It is preferred if the recess communicates with a sensor holder in which a component of the at least one sensor, for example an evaluation means for evaluating at least one signal from the at least one sensor is arranged or can be arranged. The sensor holder can thus protect the component of the sensor, in particular the evaluation means. The sensor holder is configured as, for example, a depression or a hole or the like in the supporting element.

It is preferred if the sensor holder is formed by the expansion cavity or, formulated differently, directly forms the expansion cavity. Thus, the sensor holder has a double function as it were, namely on the one hand to protect or receive at least one component of the sensor, and on the other hand to favourably influence the expansion characteristics or the deflection of the reference surfaces relative to one another, for example to allow a greater deflection of the reference surfaces than would be possible without the presence of the expansion cavity or sensor holder.

The sensor holder expediently communicates with at least one passage opening, through which a fastening element can be inserted for connection with the component, arranged in the sensor holder, of the at least one sensor. The fastening element is, for example, a rivet, a screw or the like.

The supporting element preferably has an assembly opening which is provided in a transverse side, angled with respect to the reference surfaces, of the supporting element. For example, the aforementioned depression or recess on which the reference surfaces are provided, extends away from a side of the supporting element, while the assembly opening is provided on a side, angled with respect to this side, for example a transverse side of the supporting element.

It is possible for two mutually opposite assembly openings to be provided, i.e. for the at least one sensor and/or an additional component of the sensor, for example the evaluation means to either be arranged through the one assembly opening or through the opposite assembly opening in the sensor holder or the recess.

A recess, sensor holder or expansion cavity can be a passage opening, i.e. it passes through the respective supporting element. However, it is also possible for the recess, sensor holder or expansion cavity to be, as it were, a blind hole or in any case a blind mount, i.e. it has a bottom and does not pass through the supporting element. For example, the recess, sensor mount or expansion cavity can be milled out of the respective supporting element.

It is preferred if a sensor element of the at least one sensor is firmly connected to at least one reference surface. For example, a capacitive, inductive or optical sensor element can be directly connected to the reference surface. It is possible, for example, to connect a strain gauge to mutually opposite reference surfaces of the recess, so that the strain gauge is extended or compressed when the supporting section is stressed and thus when the distance between the reference surfaces changes.

However, the connection does not have to be provided directly to the reference surface, i.e. the sensor element or sensor does not have to be adhesively bonded, riveted or the like directly onto the reference surface. It is also possible for the sensor or sensor element to be fixed in a stationary manner elsewhere, although the distance to the reference surface is constant or fixed. A support part, for example, which will be described later on can be provided for this purpose, which support part is connected to the deforming supporting element remote from the reference surface and holds the sensor or sensor element. The sensor element or the sensor is held in a stationary manner with respect to the reference surface by the support part, for example frontally in front of the reference surface.

It is also possible for the at least one sensor to measure as it were into the spacing between the reference surfaces, but it is not arranged between the reference surfaces. This can be carried out optically or acoustically, for example.

One sensor element of the at least one sensor is expediently associated with in each case two mutually associated reference surfaces, or it is arranged on the respective reference surface. There is a distance between the sensor elements. The sensor elements are feely movable relative to one another when the reference surfaces move relative to one another during the deformation of the supporting element.

A preferred embodiment of the invention provides that a respective sensor element or a sensor is not directly connected to the reference surface or does not have to be directly connected to the reference surface, but is arranged on a support part. The support part expediently has a holding portion for holding the sensor element or sensor. The sensor element comprises for example a capacitive and/or inductive and/or optical sensor element. The holding portion is located, for example, frontally in front of the reference surface. A fastening portion of the support part extends next to the holding portion. For its part, this fastening portion is, in turn, connected to the supporting element. For example, the passage opening for the fastening element extends to the fastening portion of the support part for the sensor, so that a screw or another fastening element can be connected to the fastening portion through the passage opening.

The support part preferably has an angular, in particular an L-shaped form.

The support part can form a component of the sensor. For example, it is possible for a sensor surface, for example a capacitive surface or electrode to be directly arranged on the holding portion.

In particular, the reference surface is provided on a free end face of an arm portion which protrudes from the supporting section. The sensor element or the sensor is arranged in front of the free end face. The sensor element or the sensor is preferably supported or held by the support part which has already been described.

The motor vehicle can be a motor vehicle with an internal combustion engine, an electric motor or both. In particular, the motor vehicle is preferably a passenger car.

The at least one sensor is preferably configured as a sensor module or it comprises a sensor module.

The sensor module thus forms a modular unit which can be arranged on the supporting element. The outer circumferential contour of the sensor module, for example of a housing of the sensor module fits in or matches the inner circumferential contour of the depression in the supporting element, for example to be received in a form-fitting manner.

A further advantageous aspect is provided when the sensor module has a sensor housing in which the at least one sensor is arranged. It is also possible to arrange in the sensor housing sensor parts which individually come into contact with the supporting element when the sensor module is mounted on the supporting element, for example a first sensor part and a second sensor part. In spite of being arranged in the sensor housing, the sensor parts are expediently movable relative to one another during a deformation of the supporting element, so that they can be at different distances from one another, and in this way a deformation of the supporting element can be carried out by the sensor module by a corresponding distance measurement, for example a capacitive, optical or inductive distance measurement.

In the following, the invention will be described in more detail with reference to an embodiment.

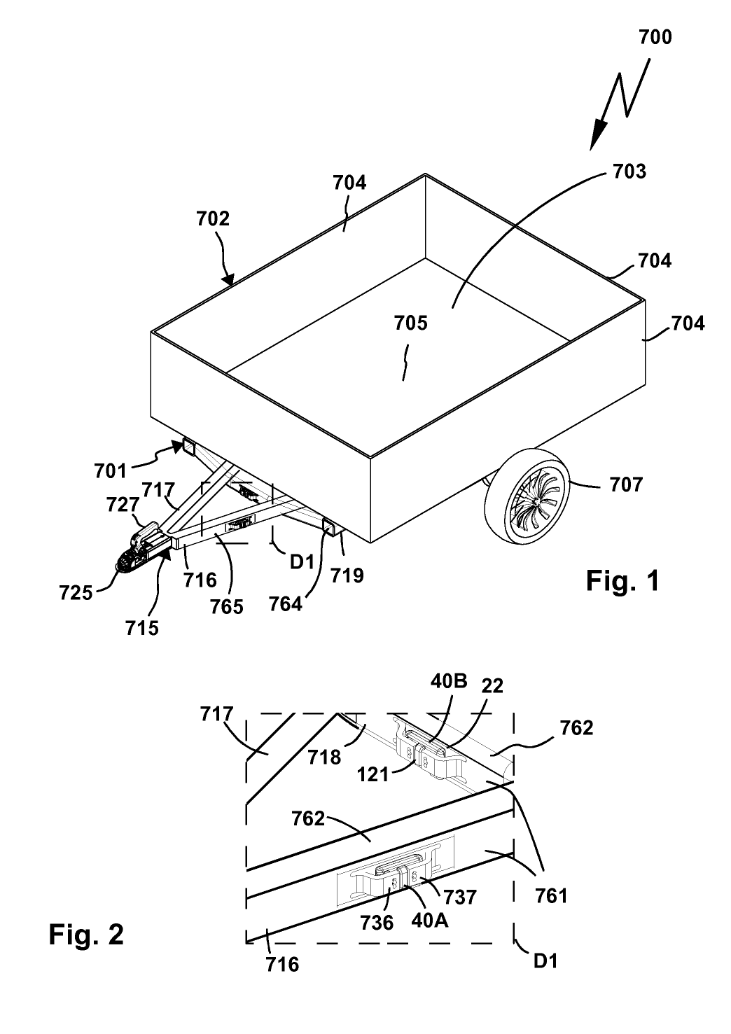

FIG. 1 is a perspective view of a trailer for coupling to a motor vehicle, of which in

FIG. 2 a detail D1 is shown,

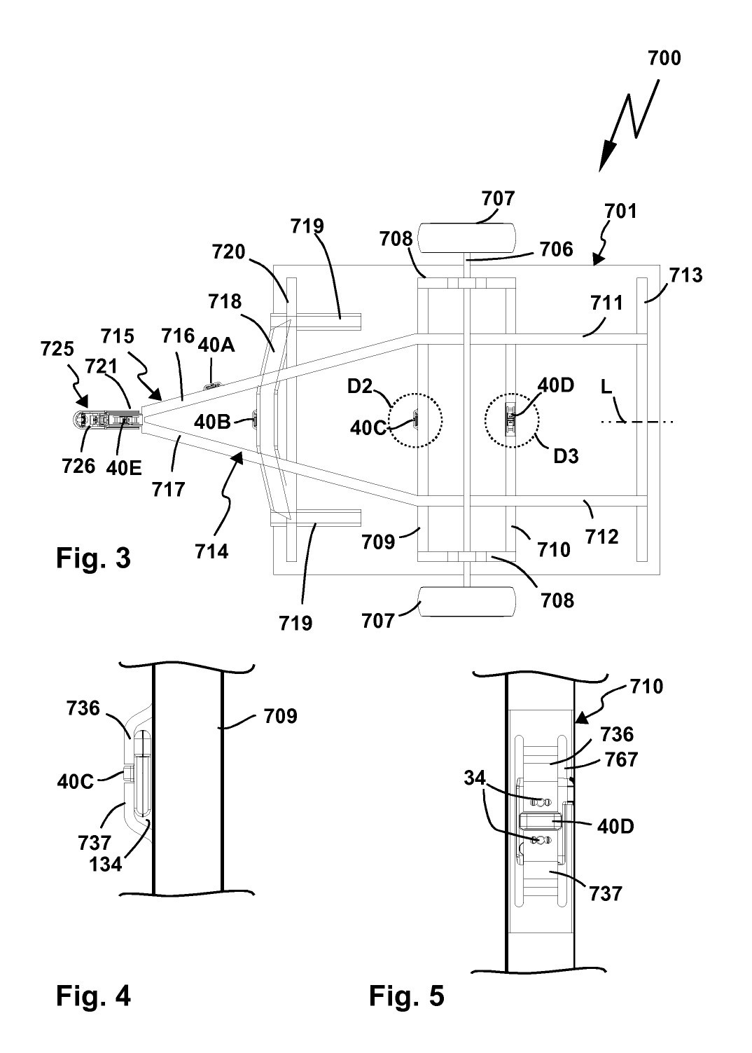

FIG. 3 is a view from below of the trailer according to FIG. 1, of which in

FIG. 4 a detail D2 is shown and in

FIG. 5 a detail D3 is shown,

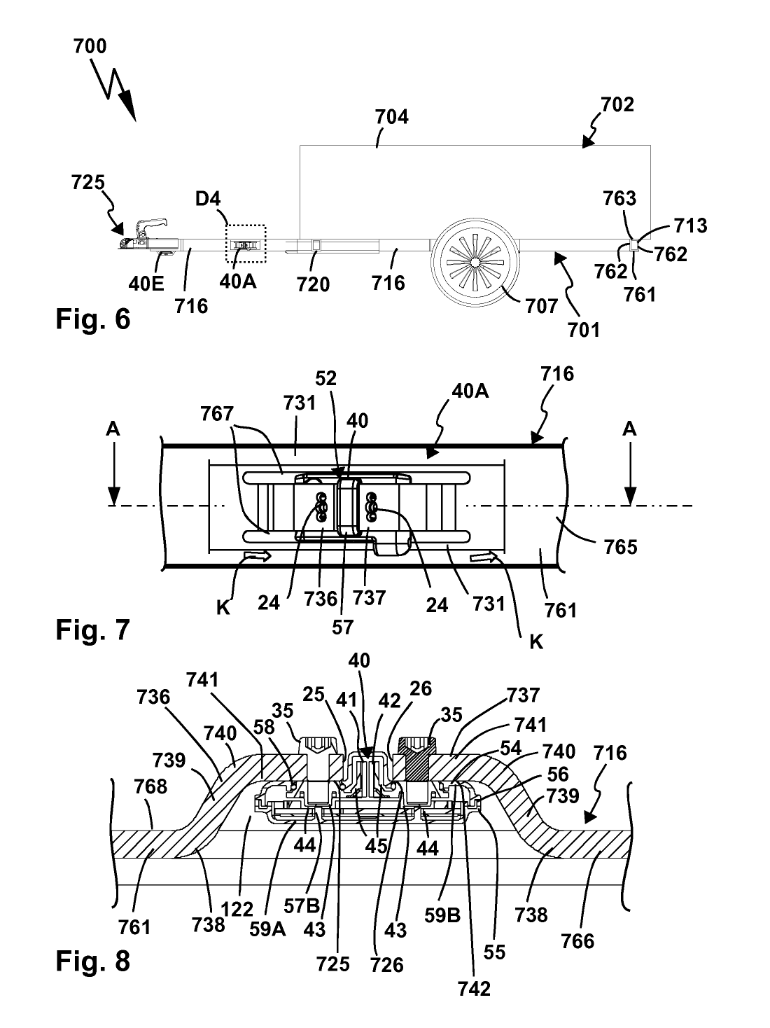

FIG. 6 is a side view of the trailer according to the above figures, of which in

FIG. 7 a detail D4 is shown,

FIG. 8 is a cross-sectional view through detail D4 according to FIG. 7 along a line A-A in FIG. 7,

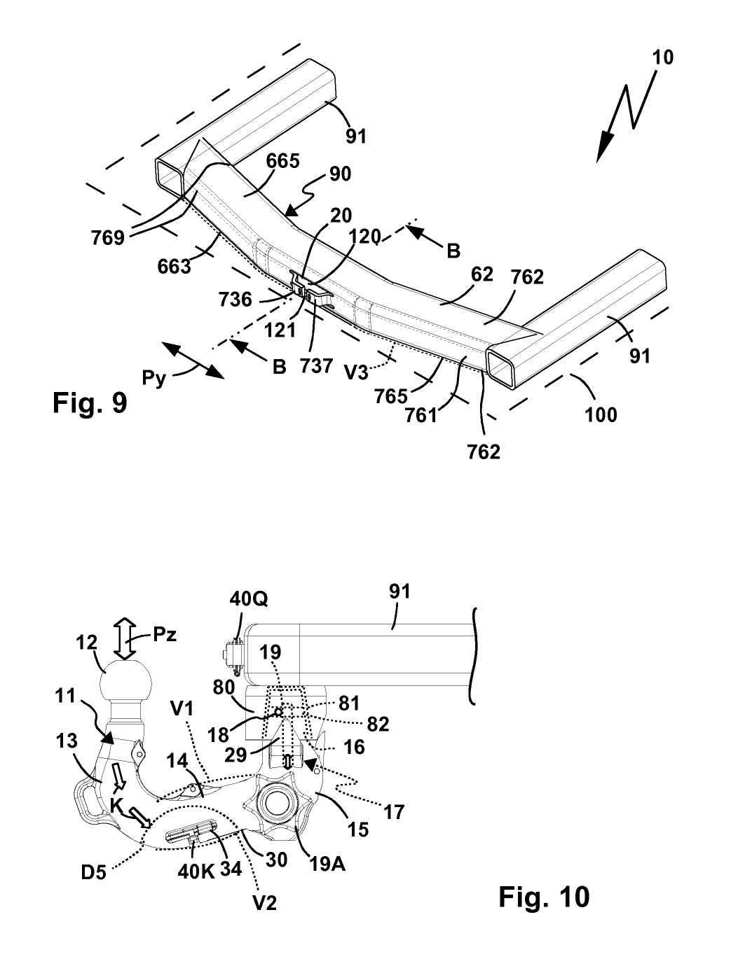

FIG. 9 is a perspective oblique view of a trailer coupling having a supporting element according to the invention, which in

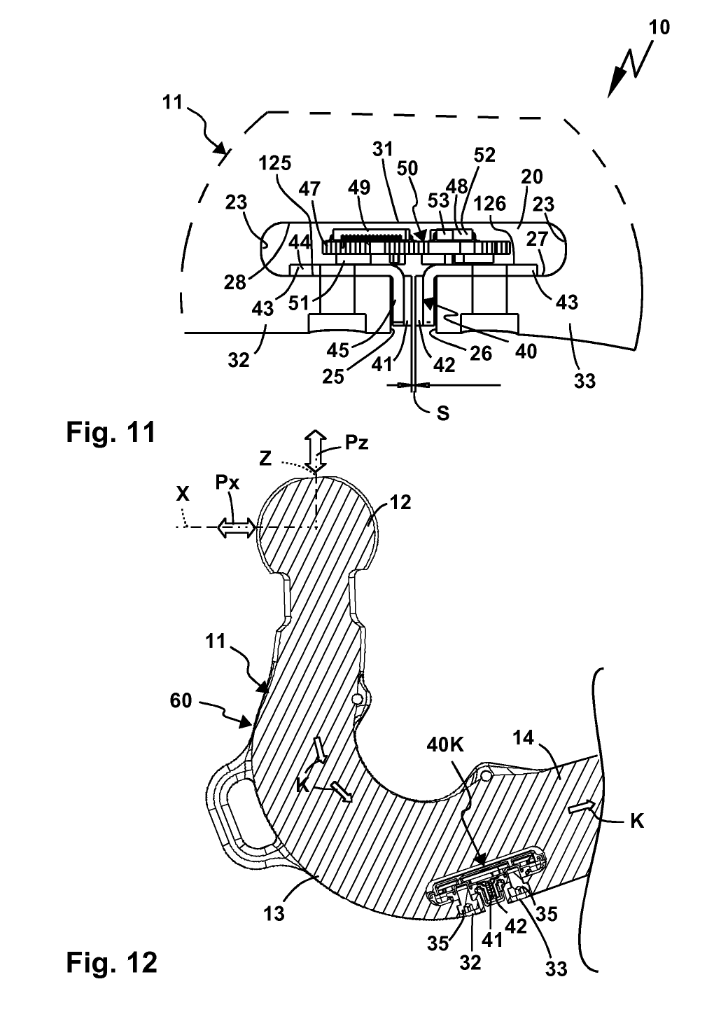

FIG. 10 is shown from the side, and has a coupling arm,

FIG. 11 shows a detail D5 of the coupling arm according to FIG. 10 with a sensor, but without a sensor housing,

FIG. 12 is a longitudinal sectional view through the coupling arm according to FIG. 10, 11,

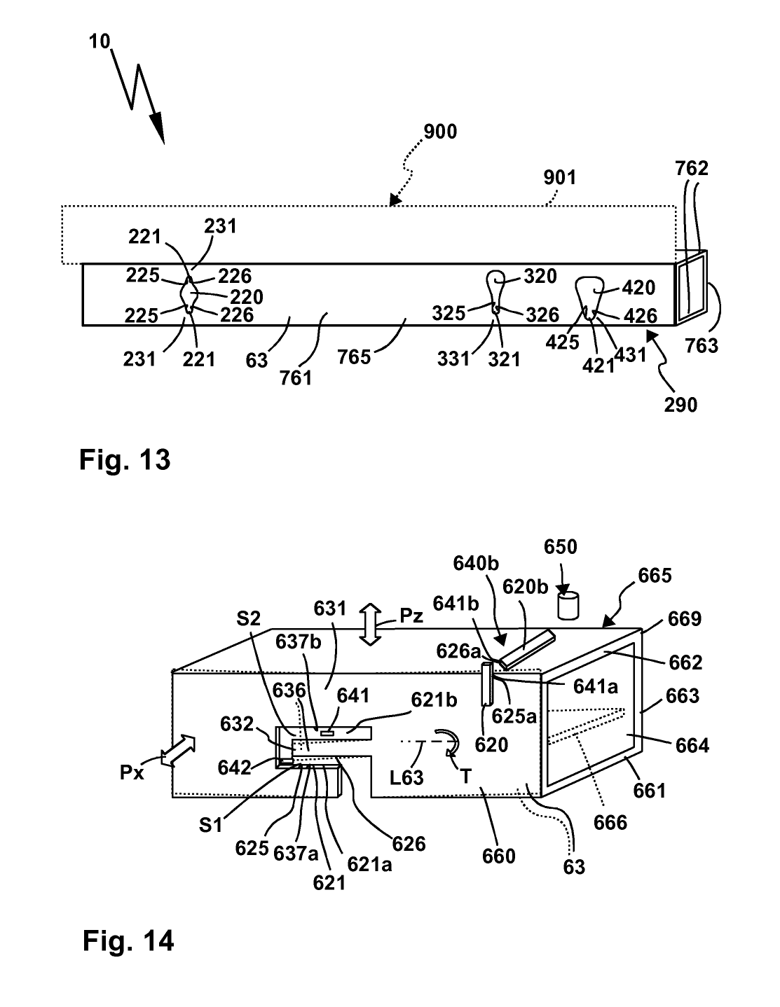

FIG. 13 is a schematic front view of a supporting element as a component of a trailer or a load carrier, for example,

FIG. 14 shows a schematic embodiment of a supporting element as a component of a trailer coupling, of a load carrier or of a trailer, in which a recess which indicates an expansion or deformation of the supporting element and is detected sensorially is provided next to a tongue-like element of the supporting element,

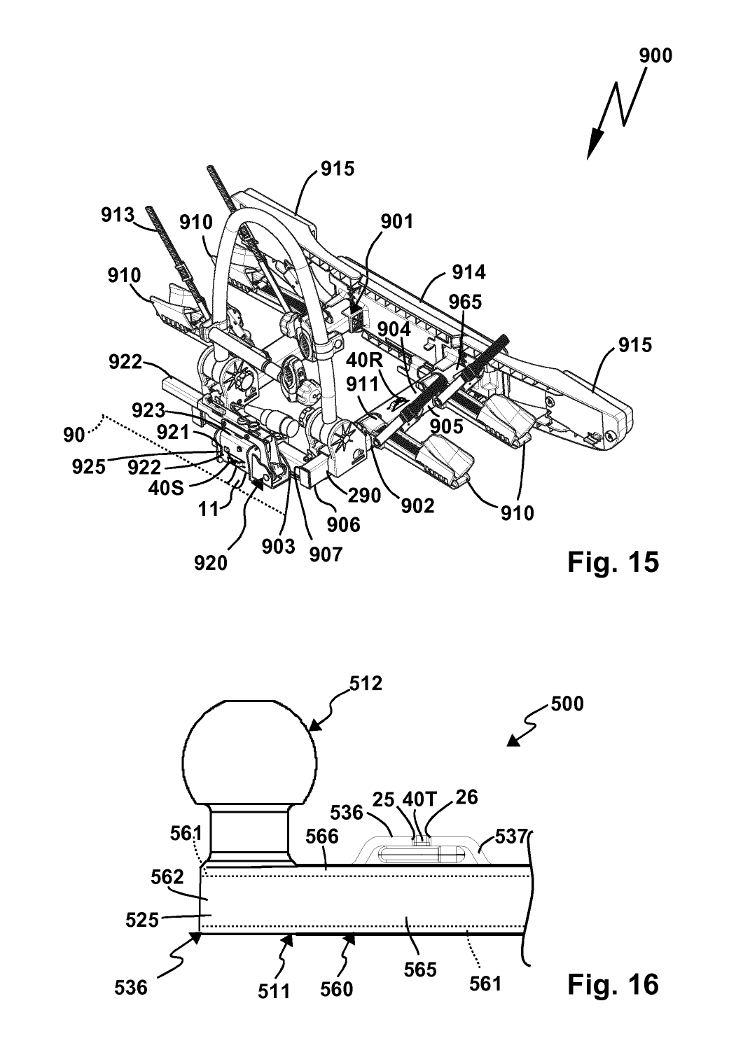

FIG. 15 shows a load carrier with sensor elements, and

FIG. 16 shows a coupling arm with a coupling element on a profiled body, on which a sensor is arranged.

A trailer 700 comprises a chassis 701 which is used to support a trailer structure 702. The trailer structure 702 comprises, for example, a bottom wall 703, from which side board walls 704 project upwards, so that overall a receiving space 705 is enclosed. The trailer structure 702 can naturally be configured differently, for example it can comprise a box, a supporting platform or the like.

The chassis 701 has an axle 706 on which wheels 707 are rotatably mounted. The axle 706 is held, for example, on axle carriers 708 which, for their part, are held by cross members 709, 710. The cross members 709, 710 extend transversely to a longitudinal axis L of the trailer 700 and are connected to longitudinal members 711, 712, for example, which extend in a longitudinal axis L of the trailer 700. Furthermore, the longitudinal members 711, 712 are interconnected in a rear region of the trailer 700 by a cross member 713 which extends transversely to the longitudinal axis L.

Projecting in the direction of travel in front of the trailer 700 is a tow bar 715 of the chassis 701, on the free end region of which is provided a coupling means 725, configured in particular as a ball coupling, for coupling to a coupling piece, for example to the coupling piece 12 which will be described later on. The coupling piece 12 is configured as a ball, for example. The coupling means 725 has, for example, a coupler pocket 726 for receiving the coupling piece 12, as well as an actuating element 727 for opening and closing the coupler pocket 726.

The tow bar 715 has supporting arms 716, 717 which run towards one another at an angle to one another in the direction of the coupling means 725 and are interconnected, for example, by a crossbar 718. The supporting arms 716, 717 merge into the longitudinal members 712, 711 at their end regions remote from the coupling means 725, a corresponding angular portion being located in this transition region. This angular portion is connected to the cross member 709.

The crossbar 718 extends between longitudinal members 719 which are fastened to the trailer structure. The crossbars 718 can be interconnected by a cross member 720 which extends transversely to the longitudinal axis L.

A coupling supporting element 721 is arranged in the free end region of the supporting arms 716, 717 and it supports the coupling means 725.

The cross members 709, 710, 713, the longitudinal members 711, 712 and the components of the tow bar 715, in particular the supporting arms 716, 717 and the coupling supporting element 721 form chassis components 714.

In the following, the chassis components 714 will uniformly be called supporting elements 61. The chassis components 714 or supporting elements 61 have a respective profiled body 765, formed as a hollow profile. The profiled body 765 has, for example, a supporting wall 761, from which supporting walls 762, 762 project and opposite which is a supporting wall 763 which is also connected to the supporting walls 762, 762. The supporting walls 761-763 define a cavity 764.

When the trailer structure 702 is subjected to a load, this load is taken up by the chassis 701. The components 714 of the chassis 701, for example the supporting arms 716, 717 of the tow bar 715 have to support the load and are deformed under this stress. Tensile forces and shear forces act on the chassis 701 also in the direction of the longitudinal axis L, which tensile forces and shear forces lead to deformations of the chassis components 714.

Sensors 40A-40E which are arranged on a respective supporting wall 761 are used to detect stresses and deformations of this type. For example, sensor 40A is arranged on the tow bar 715, in particular on the supporting arm 716. Sensor 40B is arranged on the crossbar 718. Sensor 40C is arranged on the cross member 709 and sensor 40D is arranged on the cross member 710. Finally, sensor 40E is arranged on the coupling supporting element 721 in the free end region of the supporting arms 716, which coupling supporting element bears the coupling means 725.

The purpose of sensors 40A and 40B is to measure a tensile load or a support load, for example.

Shown on a load carrier 900 are for example sensors 40S and 40R which can measure, for example, loads of a supporting frame 901 of the load carrier 900.

The supporting frame 901 has, for example, a basic support 903, from which the supports 902 project in the manner of U-shaped side limbs. The basic support 903 can be fitted with a sensor 40R, as can one or both of the supports 902. The supports 902, 903 are preferably profiled bodies 965 or in any case supporting elements which have mutually angled supporting walls, for example supporting walls 904 and 905. Further supporting walls 906, 907 can be located opposite the supporting walls 904 and 905, so that a closed profile which is in particular approximately rectangular in cross section, of the profiled body 965 is formed overall. For example, sensor 40R is arranged on supporting wall 904.

Supporting elements 910, for example supporting grooves for locating bicycles can be arranged on the supporting frame 901. The supporting elements 910 can be expediently adjusted by bearings 911 between the use position or supporting position, shown in FIG. 15, and a non-use position provided for non-use in which they are swivelled, for example into a gap between the supports 902. Fastening elements 913, for example straps, supports or the like are preferably arranged on the supporting elements 910. A license plate holder 914 is arranged on the longitudinal end regions, remote from the basic support 903, of the supports 902. Lights 915 are preferably arranged, in particular swivelably, on the license plate holder 914.

A coupling device 920 for releasably fastening to the coupling piece 12 can be provided, for example, on the supporting frame 901. The coupling device 920 has a housing 921 which also comprises a profiled body 925. The profiled body 925 has supporting walls 922, 923 which are interconnected and are at an angle to one another, sensor 40S being arranged on supporting wall 922, for example.

In the case of a trailer coupling 500 shown schematically in FIG. 16, a coupling piece 512, for example a coupling ball is arranged on a coupling arm 511. The coupling arm 511 comprises a profiled body 565 which forms a supporting element 560. The profiled body 525 has supporting walls 561, 562 which are at an angle to one another and are interconnected, for example by corners or by arcuate sections. In the operating state, for example the mutually opposite supporting walls 561 form upper and lower walls, while the mutually opposite supporting walls 562 form side walls of the profiled body 565. One supporting wall 562 respectively connects two supporting walls 561. The profiled body 525 has, for example, a rectangular cross section. The supporting walls 561, 562 define a cavity or interior of the profiled body 525.

Located on the upper supporting wall 561 in the drawing is a sensor 40T which can measure a load on the supporting element 560. Projecting from the supporting wall 561 are for example indicator elements 536, 537, in the free mutually opposite end regions of which are provided the reference surfaces 25, 26 for the sensor 40T. The indicator elements 536, 537 are integral with the supporting wall 561. The indicator elements 536, 537 are advantageously configured in the manner of tongues which protrude in front of supporting wall 561. For example, the indicator elements 536, 537 are stamped and formed from a plate-like wall body 566 of supporting wall 561.

The sensors 40A-40E, 40R, 40S, 40T are constructed similarly or identically to a sensor 40K which is provided on a coupling arm 11 of the trailer coupling 10 described in the following. Thus, sensor 40K is used to describe and to provide an understanding of the sensors 40A-40E, 40R, 40S, 40T.

The coupling arm 11 can be fastened to a holder 80 on the vehicle by means of an insertion portion 16. The holder 80 has an insertion seat 81 for the insertion of the insertion portion 16. The coupling arm 11 can be locked with the holder 80 by a locking means 17. The locking means 17 comprises a displacer 19, for example a locking bolt which is received displaceably in a guide (not shown) of the coupling arm 11. The displacer radially displaces blocking bodies 18, for example balls, outwards through openings (not shown) in the insertion portion 16 in front of the insertion portion 16, where they engage in at least one locking mount 82, in particular a groove, of the holder 80. The displacer 19 can be actuated, for example, by a hand wheel 19A.

Contributing to the further support and to the retention of the coupling arm 11 on the holder 80 are furthermore form-locking contours 29, for example wedge bevels on the sides of the insertion portion 16 which engage in a form-locking manner into corresponding form-locking mounts of the holder 80. The locking bodies which pass outwards through the openings 18 draw the insertion portion 16, as it were, into the insertion seat 81 and, in so doing, they simultaneously draw the form-locking contours 29 into the form-locking mounts, so that the coupling arm 11 is held firmly on the holder 80.

The holder 80 is fastened to a cross member 90 which, for its part, is fastened to the rear of the motor vehicle 100 by means of longitudinal members 91. The motor vehicle 100 is, for example, a passenger car. The cross member 90 runs transversely on the rear of the motor vehicle 100. The cross member 90 and the holder 80 can form components of the trailer coupling 10. As an alternative to this construction, it would be possible, for example, for the coupling arm 11 to be fixedly attached, for example screwed or the like, to the cross member 90. Furthermore, it is possible to mount the coupling arm 11 such that it is movable relative to the motor vehicle 100, in particular to the cross member 90, for which purpose a swivel bearing and/or a sliding bearing is then possible between the coupling arm 11 and the cross member 90 or another component supporting the coupling arm 11 (not shown). Finally, it is mentioned in passing that instead of the coupling arm 11, it is also possible to provide another supporting element, for example a supporting arm for a load carrier. A supporting arm of this type or the aforementioned holder, in particular also the swivel bearing or sliding bearing can also be provided with recesses and an associated sensor system in the manner described in the following, in order to optimally detect deformations of the respective supporting element.

In its free end region, the coupling arm 11 has a coupling piece 12, for example a coupling ball. The end region of the coupling arm 11 is located at the end of a curved portion 13. Located between the curved portion 13 and a further curved portion 15 which adjoins the insertion portion 16 is a substantially straight arm portion 14 of the coupling arm 11.

All the aforementioned portions of the coupling arm 11, but in particular the straight arm portion 14, are deformed as a result of being stressed by a load, for example by a support load Pz in the axial direction of an axis Z, or by a tensile load/shear load Px in an axial direction X. This is particularly the case for the arm portion 14, but also for the curved portions 13, 15.

The introduction of a force onto the coupling piece 12 results, for example, in a force flow K which is shown by way of example in FIG. 12. Consequently, the coupling arm 11 is deformed, for example along a curved line V1 or a curved line V2, depending on whether a positive or negative support load Pz acts on the coupling piece 12. The deformation is elastic.

The stress on the coupling arm 11 also acts in a similar way on the cross member 90. A deformation V3 takes place, for example, on the cross member 90 when it is subjected to a tensile load. In this case, a tensile load is a load in the X direction or in the direction of travel of the motor vehicle 100 if, for example a trailer is coupled to the coupling arm 11.

A deformation or curvature of the coupling arm 11 which forms a supporting element 60, or of the cross member 90 which forms a supporting element 62 is detected by the sensor arrangement comprising sensors 40K and 40Q which is described in the following.

Arranged on the coupling arm 11 and on the cross member 90 are sensors 40K and 40Q which, for their part, comprise sensor elements 41, 42 which are arranged in recesses 21, 121.

The recess 21 is located, for example, on an underside 30 of the coupling arm 11.

The cross member 90 forms a supporting element 62 which is also configured as a profiled body 765, and thus has the supporting walls 761-763 which form a closed profiled body 765. The sensor element 40Q is provided on the supporting wall 761 of the supporting element 62. Like sensor elements 40A-40E, sensor element 40Q is provided in or on a recess 121 located between the indictor elements 736, 737.

The indicator elements 736, 737 are integral with supporting wall 761. They are configured in the manner of tongues which protrude in front of supporting wall 761. For example, the indicator elements 736, 737 are stamped and formed out of a plate-shaped wall body 766 of supporting wall 761. The indicator elements 736, 737 are for example stamped bent parts which are stamped and formed out of the wall body 766. As a result, in the wall body 766 there is a cutout 767, in front of which the indicator elements 736, 737 protrude. The cutout 767 is a passage opening which communicates with the cavity 764.

The indicator elements 736, 737 have foot portions 738 which run, for example, in a curved manner out of the wall body 766 and merge into a transition portion 739, protruding in front of a flat side 768 of the wall body 766. For its part, the transition portion 739 merges with an arcuate section 740 into an end portion 741. The end portions 741 of the indicator elements 736, 737 are opposite one another, the recess 121 being present between their end faces.

The recess 21 is constructed slightly differently. For example, it is produced as a hole or as a milled-out portion in the coupling arm 11, and is produced from solid material, as it were. Nevertheless, it is possible in the case of the coupling arm 11 and the supporting element 60 and the supporting elements 61, 62, to use the same sensors 40A-40E, 40K, 40Q which are simply called sensor 40 in the following.

The recesses 21, 121 comprise mutually opposite walls which form reference surfaces 25, 26. The sensor elements 41, 42 are at least indirectly arranged on these reference surfaces 25, 26. During a deformation of the coupling arm 11 which forms a supporting element 60 of the trailer coupling 10, the reference surfaces 25, 26 move towards one another or away from one another, so that a gap S between the sensor elements 41, 42 increases or decreases. The sensor elements 41, 42 measure, for example capacitively, inductively, optically or in any other such manner, a distance between one another, i.e. the width of the gap S. At the same time, this is an indication of the deformation of the coupling arm 11, i.e. of the supporting element 60.

An expansion cavity 20, 120 is located next to the respective recess 21, 121. The recess 21, 121 and the expansion cavity 20, 120 communicate directly with one another.

The recess 21, 121 and the expansion cavity 20, 120 are at an angle to one another, for example at right angles to one another. The recesses 20, 121 and the respectively associated expansion cavities 20, 120 form, for example a T-shaped configuration. In the case of the coupling arm 11, the supporting element 60, the expansion cavity 20 is produced as a milled-out portion or as a hole. In the case of the supporting elements 61, 62, the expansion cavity 120 is produced by providing the cutout 767 between the indicator elements 736, 737 and the wall body 766.

The expansion cavities 20, 120 and the recesses 20, 121 are open at the sides, thus they have assembly openings 34, 134 on mutually opposite sides of the coupling arm 11, so that the sensors 40 and the evaluation means 50, described in more detail in the following, can be easily fitted and removed. Consequently, the sensors 40 and the evaluation means 50 associated therewith form sensor modules or in any case compact modular units which are easy to assemble and to disassemble.

The evaluation means 50 are arranged in the expansion cavities 20, 120 which thus form sensor mounts 22, 122. The expansion cavities 20, 120 preferably fully accommodate the evaluation means 50, so that they do not protrude in front of an outer surface next to the expansion cavities 20 and are thus protected in an optimum manner.

The sensor elements 41, 42 are arranged on support parts 43 which have an angular form. The support parts 43 have fastening portions 44 and also holding portions 45 which are at an angle thereto. The holding limbs or holding portions 45 respectively support one of the sensor elements 41, 42. Consequently, the two holding portions 45 hang, as it were, in front of the respective reference surfaces 25, 26.

The support parts 43 are connected, namely for example screwed, riveted or the like to the coupling arm 11 on the fastening portions 44. For example, screws 35 pass through passage openings 24 which communicate with the expansion cavity 20, 120 or with the sensor mount 22, 122. The screws 35 are screwed into the fastening portions 44.

Thus, the fastening portions 44 are connected to a bottom surface 27 of the sensor mount 22. However, the sensors 40 and the evaluation means 50 have no contact with a top surface 28, opposite the bottom surface 27, of the sensor mount 22, but are at a distance therefrom. This also applies to longitudinal end regions 23 of the senor mount 22, the support parts 43 as well as the evaluation means 50 being at a distance therefrom. Consequently, the contact of the sensors 40A, 40B and of the evaluation means 50 is thus restricted to the bottom region 27, as it were. The evaluation means 50 and the sensors 40A, 40B are also not in contact with a supporting section 31, extending along the top surface 28, of the supporting element 60 or coupling arm 11. This supporting section 31 can as it were freely deform when the coupling arm 11 is stressed, for example by the support load Pz, the tensile load Px or also in a direction transverse thereto, namely in the so-called vehicle transverse direction, in the direction of a Y axis with a force Py.

Extending next to the sensor mount 22 or to the expansion cavity 20 are, as it were, arms 33, 32, the outside of which is formed by the underside 30 of the coupling arm 11, but the insides of which are associated with the expansion cavity 20 and support the fastening portions 44 of the support parts 43.

The reference surfaces 25, 26 are formed by the free end faces of the arms 32, 33 or are arranged thereon.

The arms 33, 32 can be considered, for example as indictor elements like the indicator elements 736 and 737.

It is seen that the contact of the sensors 40 is restricted to the indicator elements 736, 737 which, as it were, lie outside the force flow through the respective supporting element 61-62, but they can detect a deformation of the supporting element 61, 62 which results due to this force flow. In the case of the sensor mount 122, the fastening portions 44 of the support parts 43 are connected to side faces 742 of the indictor elements 736, 737. The side faces 742 are expediently oriented parallel or at a flat angle to the flat side 768 of the wall body 766.

It is pointed out here that the sensor elements 41, 42 could naturally be directly arranged on the reference surfaces 26, for example they could be adhesively bonded thereon, or they can be connected to the respective reference surfaces 25, 26 in another way. The sensor elements 41, 42 exclusively have contact with the free end regions of the indictor elements 736, 737, i.e. with the end portions 741. However, at the side, i.e. for example at the transition portions 739 of the indictor elements 736, 737, there is no contact between the sensors 40 and the respective supporting element 61, 62. In addition, the sensors 40 of the supporting elements 61, 62 are arranged above the cutout 767, i.e. that similarly to the sensor 40 on the coupling arm 11, they have no contact with a wall surface opposite the reference surfaces 25, 26 or 725, 726.

The force flow K through the supporting elements 61, 62 runs past the sensors 40A-40E, as it were, via a supporting section 731, but the indicator elements 736, 737 transmit the deformation, caused by this force flow, of the supporting element 61, 62 to the respective sensor 40A-40E, so that the sensor can detect a corresponding stress of the supporting element 61, 62.

The evaluation means 50 comprise a support 47, for example an electrical printed circuit board or board, on which evaluation elements, for example a microprocessor 49, measuring elements 48, a bus coupler 51 or any other such elements are arranged for evaluating sensor signals from the sensor elements 41, 42.

The evaluation means 50 can evaluate sensor elements 41, 42. For this purpose, for example stored in a memory 52 is an evaluation program 53 which has a program code which can be implemented by the microprocessor 49.

The sensors 40 advantageously have a respective sensor housing 54. The evaluation means 50, for example, is accommodated in a protected manner in the sensor housing 54. The sensor elements 41, 42 are expediently also accommodated therein in a protected manner.

The sensor housing 54 comprises, for example, a housing lower part 59A and a housing upper part 59B which are interconnected in a peripheral region 55. The housing lower part 59A and the housing upper part 59B are configured, for example, as housing shells. A seal 56, for example, can be provided on the peripheral region 55. The seal 56 is realised, for example, in that the two housing parts 59A 59B engage in one another in a labyrinth-like manner (a labyrinth seal is provided on the peripheral region 55) and/or a seal seat and/or an O ring is provided between the two components in the peripheral region 55. Provided on the housing upper part 59B are passage openings for the screws 35, on which passage openings seals 58 are preferably provided in each case. For example, the fastening portions 44, with corresponding screw bosses or screw projections, partly pass into the passage openings in the housing upper part 59B which are sealed there on the periphery by the seals 58. Thus, the seals 58 are provided, for example, between the fastening portions 44 and the housing upper part 59B.

Also provided on the housing upper part 59B is a dome 57 which extends into the slot or recess 21 and receives the sensor elements 41, 42 in a protective manner. The dome 57 could also be called a protective housing or a protective casing for the sensor elements 41, 42. The sensor elements 41, 42 are arranged in the dome 57 such that they are movable relative to one another.

The housing upper part 59B is connected to the housing lower part 59A, for example by at least one snap-in nose and/or by a screw connection and/or by an adhesive bond.

The support 47 is supported, for example, on props 57B of the housing lower part 59A.

In particular, to evaluate the force Py which is effective in the transverse direction, it is advantageous if a plurality of sensor elements, for example capacitive or inductive sensor elements are arranged in or next to a respective slot or recess 21, 121 in the longitudinal direction of the recess 21, 121 or transversely to the force flow K.

Furthermore, it becomes clear from an embodiment which is also shown in FIGS. 8 and 11 that reference surfaces 125, 126 and 725, 726 which are located inside the expansion cavity 20, 120 are also free from the force flow through the supporting section 31. The reference surfaces 725, 726 of the indicator elements 736, 737 are provided, for example, on the side faces 742. The sensor elements 41, 42 or the support parts 43 bearing the sensor elements 41, 42 are connected to these reference surfaces 125, 126 or 725, 726, for example they are adhesively bonded therewith and/or are connected thereto by the screw connection with the screws 35 through the passage openings 24. Thus, the sensor elements 41, 42 move synchronously with a movement of the reference surfaces 125, 126 or 725, 726, so that they can detect a relative movement of the reference surfaces 125, 126. It is also clear from this embodiment that the reference surfaces 125, 126 or 725, 726 do not have to be directly opposite one another, as for example the reference surfaces 25, 26, but they can also be arranged next to one another, for example.

FIG. 13 shows an embodiment which is to be understood schematically. For example, provided in the cross member 290, which forms a supporting element 63, are recesses 221, between which an expansion cavity 220 is located.

The cross member 290 can serve, for example, as a supporting element for the trailer 700 or for the load carrier 900.

For example, the cross member 290 forms a strut, a support or another component of the supporting frame 901, shown schematically in FIG. 13, of the load carrier 900.

The profiled body 665 is suitable, for example, as cross member 290. The recess 221 is provided in the supporting wall 661 of said profiled body.

A supporting section 231 of the cross member 90 runs past a respective recess 221. The recesses 221 have respectively mutually opposite reference surfaces 225, 226, with which are associated sensors or sensor elements, for example the sensor elements 41, 42 which are not shown in the drawing.

Also provided by way of example on the cross member 290 is a keyhole-type contour, the lower region of which forms a recess 321 which has mutually opposite reference surfaces 325, 326. Sensor elements can also be provided there in the manner of sensor elements 41, 42. The broader or wider region, as it were, of this keyhole forms an expansion cavity 320. During a deformation of a supporting section 331 which extends next to the recess 321, the recess 321 becomes wider or narrower, which is accordingly detected by the appropriate sensor system, for example by sensor 40a, 40b.

A substantially triangular recess is shown by way of example further to the right on the cross member 290. The triangular recess has a narrower lower region which, as recess 421 with reference surfaces 425, 426, is the measuring cavity, as it were. The upper region of the recess is wider or broader and forms an expansion cavity 420. When a supporting section 431 next to the recess 421 deforms, the cross width of the recess 421 changes, and thereby the distance between the reference surfaces 425, 426 also changes. A capacitive, inductive or any other such sensor element, suitable for measuring a distance, can be associated, for example, with the reference surfaces 425, 426, for example in the manner of the sensor 40a, 40b.

Incidentally, it is mentioned that in all the aforementioned embodiments in the drawings, but also in the case of another trailer coupling according to the invention, the respective sensor or the evaluation means can communicate with, for example an electrical system of the motor vehicle in a wired or wireless way or in both ways. For this purpose, the sensor [ . . . ] these evaluation means preferably has, for example, a bus coupler, a line connection, a wireless interface or the like.

Alternatively, it would also be possible for the arms 32, 33 or the indicator elements 736, 737, for example, to perform a type of shear movement or swivel movement when the supporting section 31, 731 is stressed. In a variant which is not shown in the drawings, the reference surfaces swivel away from one another or towards one another, for example.

The recess which, according to the invention, is substantially free from or is completely free from a force flow can comprise, for example a kind of tongue or tongue indicator. This is also indicated in the embodiment according to FIG. 14.

A labyrinth-type recess 621 is provided in a supporting element 63 (indicated schematically), which can be, for example, an L profile, a profile which is U-shaped in cross section or a profiled tube with in particular a round or rectangular cross section. The supporting element 63 has, for example, a supporting wall 660, in which the recess 621 is provided. Projecting from the supporting wall 660 are supporting walls 661, 662 which, for their part, are interconnected by a supporting wall 663 which is opposite supporting wall 660. Thus, a closed profile, which defines a cavity 664 and is for example rectangular or square in cross section, of a profiled body 665 is formed which is the supporting element 63.

A tongue-like indicator element 636 which projects into the recess 621 is provided in the recess 621 having portions 621a and 621b. The indicator element 636 forms or comprises, for example, a projection 632. During a deformation of the supporting element 63 (indicated in dashed lines), the indicator element 636 moves backwards and forwards in the recess 621. As a result, for example sensors 641 and 642 which are associated with the portions 621b and 621a can measure different distances S1 and S2 between the indicator element 636 and the adjacent walls 637a, 637b of the recess 621. For example, side faces of the indicator element 636 and the associated wall 637a or 637b form the reference surfaces 625, 626, the relative distance of which can be detected by the sensors 641, 642. The recess 621 runs next to a supporting section 631 of the supporting element 63. It can be seen that the sensors 641, 642 do not have to be arranged directly at the distances S1 or S2, as is the case, for example, for sensor element or sensor 642.

The profiled body 665 could, however, also be a T-shaped profiled body, so that a supporting wall 66 projects at an angle from supporting wall 660, for example. This is to help understand that for example, the profiled body 765 can also be configured as a U-shaped or L-shaped or T-shaped profile. In the case of a U-shaped profile, for example only the supporting walls 761, 762 are present and in the case of an L-shaped profile, for example only the supporting wall 761 and one of the supporting walls 762 is present.

The supporting walls 761-763 or in any case at least two adjoining supporting walls can be interconnected by arcuate sections 769, for example as shown in FIG. 9. Therefore, rounded edge regions are located between these supporting walls. However, it is also possible for an angular edge, as it were, to be provided between adjacent supporting walls 761-763, as shown in FIG. 13. For example, the supporting walls 660-663 are directly interconnected in each case at an edge 669. The edge 669 is, for example, a rectangular edge.

The following is provided as an example that indicator elements or indicator projections can also be provided on different supporting walls, but can have cooperating reference surfaces:

For example, indicator elements 620, 621 are arranged on the supporting walls 660, 662. The indicator elements 620, 620b project, for example, relative to the edge 669 between the supporting walls 660, 662 or extend towards this edge 669, so that reference surfaces 625 and 626 provided on the indicator elements 620, 620b perform a movement relative to one another if the profiled body 665 is deformed. The indicator elements 620, 620b are or comprise, for example, bodies or tongues which are connected in a rod-shaped manner to the supporting walls 660, 662. The indicator elements can be integral with the supporting walls 660, 662, for example by being produced as a cast component, an extrusion or the like, but they can also be permanently fixed on the supporting walls 660, 662, for example by welding or adhesive bonding.

An electrical capacitance can be detected on the reference surfaces 625a and 626b, for example, using capacitive sensor surfaces 641a and 641b of a sensor 640b, to thus determine a measurement of the stress on the supporting element 63, for example in the case of a torsion T about a longitudinal axis L63 of the supporting element 63 or a stress Pz or Px transversely to the longitudinal axis L63. To evaluate the capacitance at the sensor surfaces 641a and 641b, the sensor 640b has for example a schematically shown evaluation means 650 which is connected to the sensor surfaces 641a and 641b. The evaluation means 650 is configured identically to or similarly to the evaluation means 50. However, the distance between the reference surfaces 625 and 626 could also be detected optically or magnetically.

The reference surface 625a, 626a are provided, for example, on end faces and/or longitudinal sides of the indicator elements 620, 620b.

1. A supporting element as component of a motor vehicle trailer coupling or of a trailer intended for coupling to a motor vehicle trailer coupling or of a load carrier, wherein the supporting element comprises at least one sensor for sensing a deformation of the supporting element caused by a load acting on the supporting element, wherein at least one recess is provided in the supporting element for the at least one sensor in the region of a supporting section, which deforms when stressed by the load, of the supporting element, wherein the at least one sensor is provided for measuring a spacing of reference surfaces of the at least one recess, wherein the supporting element is configured as a profiled body having at least two supporting walls which are at an angle to one another or are interconnected by an arcuate section and include an intermediate space or cavity, at least one of the reference surfaces being provided on a passage opening of the profiled body or on an indicator element which protrudes in front of the profiled body, and the reference surfaces moving relative to one another during the deformation of the supporting element.

2. A supporting element according to claim 1, wherein the reference surfaces are arranged in particular in a spacing next to the supporting section of the supporting element.

3. A supporting element according to claim 1, wherein the reference surfaces are free from a force flow through the supporting section of the supporting element, which force flow is transmitted from the supporting section when stressed by the load acting on the supporting element.

4. A supporting element according to claim 1, wherein at least one of the reference surfaces extends transversely to a supporting section, which deforms when stressed by the load, of the supporting element.

5. A supporting element according to claim 1, wherein the reference surfaces extend lengthwise or transversely to a direction of a force flow through the supporting section, and/or in that the recess forms or comprises an expansion joint and/or in that at least one of the reference surfaces is provided on a tongue-like or arm-like indicator element or projection.

6. A supporting element according to claim 1, wherein at least one recess is provided in at least one projection or indicator element which protrudes in front of a basic body of the supporting element and/or the at least one recess comprises a depression which extends away from an opening in an outer surface of the supporting element, the reference surfaces expediently being at an angle to the opening.

7. A supporting element according to claim 1, wherein at least one recess is slot-shaped, and/or it extends over the entire cross width of the supporting element, or substantially over the entire cross width of the supporting element.

8. A supporting element according to claim 1, wherein arranged between the supporting section and the reference surfaces is an expansion cavity, the cross width of which in a direction parallel to the distance between the reference surfaces is greater than the distance between the reference surfaces, and/or in that a respective recess is arranged in opposite sides of the supporting section, and/or in that the recess has a widened zone arranged next to the reference surfaces.

9. A supporting element according to claim 8, wherein the at least one recess and the expansion cavity have overall a T-shaped or oval or egg-shaped or keyhole-shaped form.

10. A supporting element according to claim 1, wherein at least one recess communicates with a sensor mount in which a component of the at least one sensor, is arranged.

11. A supporting element according to claim 1, wherein a sensor mount is formed by an expansion cavity, or it forms the expansion cavity, and/or in that the sensor mount communicates with at least one passage opening, through which a fastening element is insertable for connection to the component, arranged in the sensor mount, of the at least one sensor.

12. A supporting element according to claim 1, wherein at least two recesses, arranged in tandem with respect to a direction of a force flow through the supporting section are provided in the supporting element, and/or at least one recess is arranged on a curved portion or on a portion, running in a substantially straight line, of the supporting element.

13. A supporting element according to claim 1, wherein supporting element, in particular the coupling arm has at least one assembly opening which is provided in a transverse side, at an angle to the reference surfaces, of the supporting element.

14. A supporting element according to claim 1, wherein a capacitive or inductive or optical sensor element of the at least one sensor is connected to at least one reference surface, and/or a respective sensor element is associated with two mutually associated reference surfaces, the sensor elements being at a distance from one another and being movable relative to one another.

15. A supporting element according to claim 1, wherein at least one sensor element of the at least one sensor is arranged on a holding portion of a support part (43) which has a fastening portion which extends next to the holding portion and is connected to a fastening region of the supporting element next to the reference surface.

16. A supporting element according to claim 1, wherein the support part has an L-shaped form and/or the holding portion and the fastening portion are formed by sides of the support part which are at an angle to one another.

17. A supporting element according to claim 1, wherein at least two sensor elements or sensors are arranged next to one another, on at least one reference surface of the at least one recess.

18. A supporting element according to claim 1, wherein at least one sensor has a capacitive sensor element and/or an inductive sensor element and/or a strain gauge and/or a distance sensor and/or an optical sensor element and/or a piezo element and/or a sensor housing in which at least one sensor element, being protected against environmental influences, and/or in that it has at least one evaluation means for evaluating at least one sensor signal from the at least one sensor.

19. A supporting element according to claim 1, wherein it exclusively forms a component of a trailer or of a load carrier, or in that the supporting element does not form a component of the motor vehicle trailer coupling.

20. A supporting element according to claim 1, wherein the supporting walls are at right angles to one another, and/or the profiled body has an L-shaped, T-shaped, U-shaped or square or rectangular cross section, and/or it has curves in cross section at least in portions or is configured as a round profile and/or as a profile which is closed in cross section.

21. A supporting element according to claim 1, wherein the indicator element is integral with at least one supporting wall of the profiled body, and/or is produced as a stamped part or stamped bent part from a wall body of the supporting wall, and/or protrudes in front of the supporting wall in the manner of a tongue.

22. A supporting element according to claim 1, wherein provided on the supporting wall are two indictor elements, on which the reference surfaces are provided, the reference surfaces being opposite one another.

23. A load carrier having a supporting element according to claim 1.

24. A trailer coupling for a motor vehicle for coupling a trailer or attaching a load carrier, having a supporting element forming a component of a cross member or of a coupling arm, according to claim 1.

25. A trailer for coupling to a motor vehicle, having a supporting element which is arranged on a chassis of the trailer, according to claim 1.
